(19) United States
(12) Patent Application Publication
(10) Pub. No.: US 2024/0168627 A1
(43) Pub. Date: May 23, 2024

(54) DISPAY DEVICE AND DRIVING METHOD THEREOF

(71) Applicant: SAMSUNG DISPLAY CO., LTD., YONGIN-SI (KR)

(72) Inventor: Dong Chun LEE, Yongin-si (KR)

(21) Appl. No.: 18/328,336

(22) Filed: Jun. 2, 2023

(30) Foreign Application Priority Data
Nov. 18, 2022 (KR) 10-2022-0155541

(51) Int. Cl. G06F 3/04886; G06V 40/12; G06V 40/13

(52) U.S. Cl. CPC G06F 3/04886; G06V 40/13; G06V 40/1365

(57) ABSTRACT

A display device includes a display, a touch sensor, and a controller. The touch sensor detects first fingers and second fingers input to a touch sensing area overlapping a display area. The first fingers are located on a user's left hand, and the second fingers are located on a user's right hand. The controller displays a virtual keyboard on the display area when an arrangement of the first fingers and the second fingers corresponds to a predetermined arrangement, and when a sum of the number of the first fingers and the number of the second fingers detected by the touch sensor is greater than or equal to a predetermined reference value.

### CROSS-REFERENCE TO RELATED APPLICATION

This application claims priority to and benefit of Korean Patent Application No. 10-2022-0155541, filed Nov. 18, 2022, which is hereby incorporated by reference for all purposes as if fully set forth herein.

### BACKGROUND

### 1. Technical Field

One or more embodiments described herein relate to a display device and a driving method thereof.

### 2. Related Art

A variety of display devices have been developed. These devices are capable of displaying multimedia content such as still and moving images. These devices are also equipped with a variety of input devices. For example, one type of display device may provide a keyboard function by outputting a keyboard interface (e.g., a virtual keyboard) on a display panel, instead of or in addition to a separate hardware keyboard.

### SUMMARY

In accordance with one embodiment of the present invention, there is provided a display device including: a display which includes a display area; a touch sensor configured to detect first fingers and second fingers input to a touch sensing area overlapping the display area, the first fingers located on a user's left hand and the second fingers located on the user's right hand; and a controller configured to display a virtual keyboard on the display area when: an arrangement of the first fingers and the second fingers corresponds to a predetermined arrangement, and a sum of the number of the first fingers and the number of the second fingers detected by the touch sensor is greater than or equal to a predetermined reference value.

The predetermined arrangement may be a horizontal line, and the controller may be configured to display the virtual keyboard on the display area when the first fingers and the second fingers are arranged in the horizontal line.

The first fingers and the second fingers may be arranged in a horizontal line when the first fingers and the second fingers lie within a virtual width, and the virtual width may correspond to a width of at least one key included in the virtual keyboard. The predetermined reference value may be 8 or another number.

When the first fingers include a thumb of the user's left hand and the second fingers include a thumb of the user's right hand, the controller may be configured to display the virtual keyboard on the display area when remaining ones of the first fingers except for the thumb of the user's left hand and remaining ones of the second fingers except for the thumb of the user's right hand are arranged in the predetermined arrangement.

The virtual keyboard may include a first virtual keyboard controlled by the user's left hand and a second virtual keyboard controlled by the user's right hand. The controller may be configured to display the first virtual keyboard on the display area based on a position of an index finger of the user's left hand and to display the second virtual keyboard on the display area based on a position of an index finger of the user's right hand. An area where the first virtual keyboard is displayed and an area where the second virtual keyboard is displayed may be spaced from each other.

The display device may include a fingerprint sensor configured to detect fingerprints of the first fingers and fingerprints of the second fingers input to a fingerprint sensing area overlapping the touch sensing area. The controller may be configured to compare the fingerprints of the first fingers detected by the fingerprint sensor with pre-registered first fingerprints and to compare the fingerprints of the second fingers detected by the fingerprint sensor with pre-registered second fingerprints as a pre-condition to display of the virtual keyboard on the display area.

The controller may be configured to display the virtual keyboard on the display area when the fingerprints of the first fingers match the pre-registered first fingerprints and the fingerprints of the second fingers match the pre-registered second fingerprints. The pre-registered first fingerprints may be fingerprints corresponding to uppermost ends of last nodes of the first fingers, and the pre-registered second fingerprints may be fingerprints corresponding to uppermost ends of last nodes of the second fingers.

In accordance with one embodiment, a method of driving a display device includes calculating a number of first fingers corresponding to a user's left hand and a number of second fingers corresponding to a user's right hand input to a touch sensing area; detecting an arrangement of the first fingers and the second fingers; and displaying a virtual keyboard on a display area overlapping the touch sensing area when: the arrangement of the first fingers and the second fingers correspond to a predetermined arrangement, and a sum of the number of the first fingers and the number of the second fingers is greater than or equal to a predetermined reference value.

Displaying the virtual keyboard may include displaying the virtual keyboard on the display area when the first fingers and the second fingers are arranged in the predetermined arrangement, and the predetermined arrangement is a horizontal line. The first fingers and the second fingers may be arranged within a virtual width, and the virtual width may correspond to a width of at least one key included in the virtual keyboard. The predetermined reference value may be 8.

When the first fingers include a thumb of the user's left hand and the second fingers include a thumb of the user's right hand, displaying the virtual keyboard may include displaying the virtual keyboard on the display area when remaining ones of the first fingers except for the thumb of the user's left hand and remaining ones of the second fingers except for the thumb of the user's right hand are arranged in the predetermined arrangement, and the predetermined arrangement may be a horizontal line.

Displaying the virtual keyboard may include displaying on the display area: a first virtual keyboard controlled by the user's left hand, and a second virtual keyboard controlled by the user's right hand. Displaying the virtual keyboard may include displaying the first virtual keyboard on the display area based on a position of an index finger of the user's left hand, and displaying the second virtual keyboard on the display area based on a position of an index finger of the user's right hand.

The method may include detecting fingerprints of the first fingers and fingerprints of the second fingers input to a fingerprint sensing area overlapping the touch sensing area, wherein displaying the virtual keyboard may include: displaying the virtual keyboard on the display area when the fingerprints of the first fingers match pre-registered first fingerprints and the fingerprints of the second fingers match pre-registered second fingerprints. The pre-registered first fingerprints may correspond to uppermost ends of last nodes of the first fingers, and the pre-registered second fingerprints may correspond to uppermost ends of last nodes of the second fingers.

In accordance with one embodiment, a display device includes a touch sensor; and a controller configured to display a virtual keyboard, wherein the touch sensor detects a number of fingers on a touch sensing area overlapping a display area, and wherein the controller is configured to automatically display the virtual keyboard when at least one condition is satisfied, the at least one condition including a first condition that the number of fingers detected by the touch sensor is greater than or equal to a predetermined reference value.

The fingers detected on the touch sensing area may be on different hands of a user. The fingers detected on the touch sensing area may be on a same hand of a user. The at least one condition may include a second condition, and the second condition may be that the number of detected fingers are arranged in a predetermined pattern. The predetermined pattern may include the number of fingers arranged on a horizontal line.

The virtual keyboard may include a first virtual keyboard and a second virtual keyboard, and the first virtual keyboard may have different keys from the second virtual keyboard. The controller is configured may display the first virtual keyboard based on a position of a predetermined finger on a user's left hand and is configured to display the second virtual keyboard based on a position of a predetermined finger on the user's right hand.

The display device may include a fingerprint sensor configured to detect fingerprints of the number of fingers on the touch sensing area, and wherein the at least one condition includes a second condition, the second condition corresponding to a match between the detected fingerprints and pre-registered fingerprints of the user.

### BRIEF DESCRIPTION OF THE DRAWINGS

The above and other features of embodiments of the present invention will become more apparent by describing in further detail embodiments thereof with reference to the accompanying drawings, in which:

FIG. 1 is a block diagram of a display device in accordance with an embodiment of the present invention.

FIG. 2 is a block diagram of a display device in accordance with an embodiment of the present invention.

FIG. 3 is a perspective view of the display device shown in FIG. 1.

FIG. 4 is a perspective view of the display device shown in FIG. 2.

FIGS. 5A and 5B are diagrams for explaining an embodiment of a calculation operation of a touch sensor.

FIGS. 6A, 6B, 6C and 6D are diagrams for explaining an embodiment of a detection operation of the touch sensor.

FIG. 7 is a diagram for explaining a virtual keyboard according to an embodiment.

FIGS. 8A and 8B are diagrams illustrating examples of implementing the virtual keyboard.

FIG. 9 is a diagram for explaining pre-registered fingerprints according to an embodiment.

FIGS. 10 and 11 are block diagrams for explaining a driving method of a display device in accordance with an embodiment of the present invention.

FIGS. 12 and 13 are block diagrams for explaining a driving method of a display device in accordance with an embodiment of the present invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In describing the drawings, like reference numerals have been used for like elements. In the accompanying drawings, the dimensions of the structures are enlarged than the actual size in order to clearly explain the invention. It will be understood that, although the terms “first”, “second”, etc. may be used herein to describe various elements, these elements should not be limited by these terms. These terms are only used to distinguish one element from another element. For instance, a first element discussed below could be termed a second element without departing from the scope of the invention. Similarly, the second element could also be termed the first element.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the following description, when a first part is “connected” to a second part, this includes not only the case where the first part is directly connected to the second part, but also the case where a third part is interposed therebetween and they are connected to each other.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

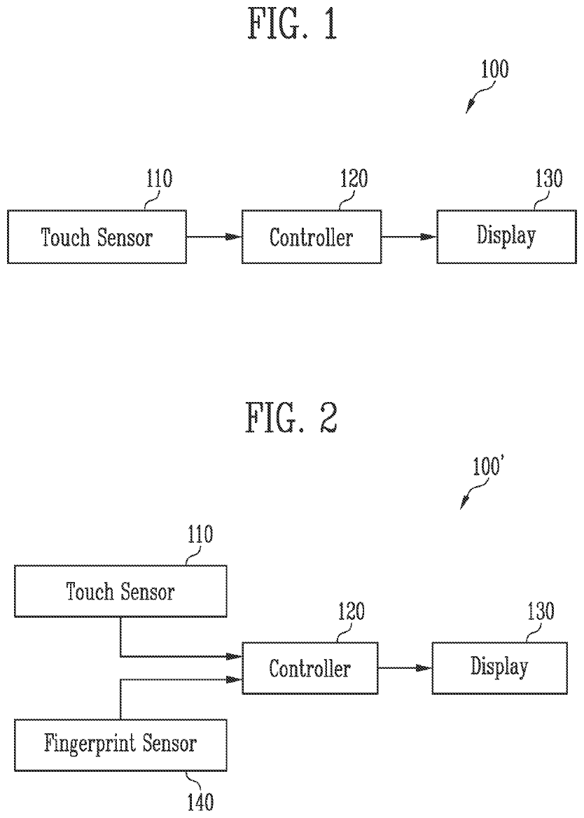

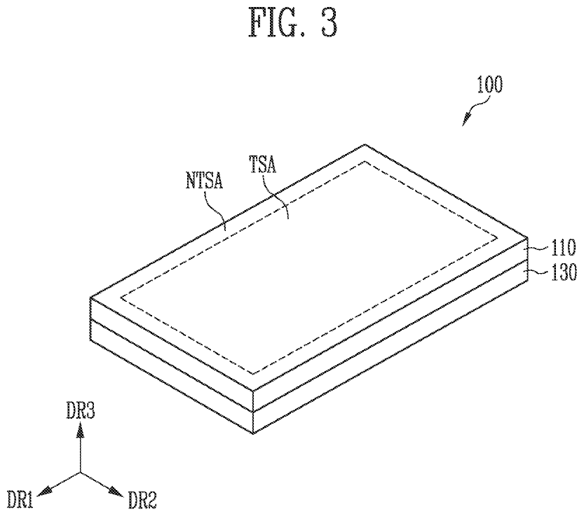

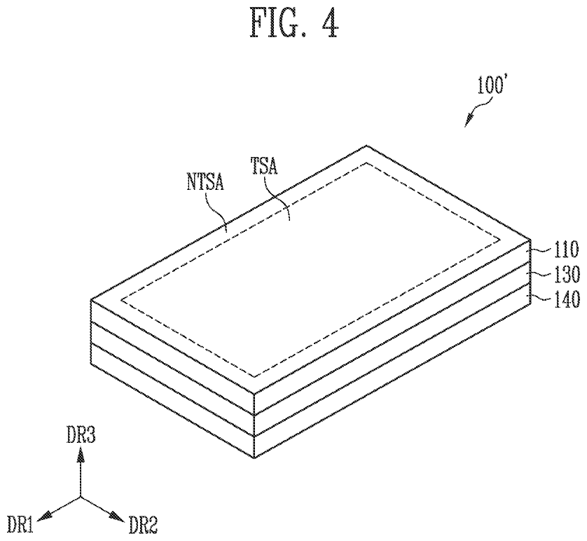

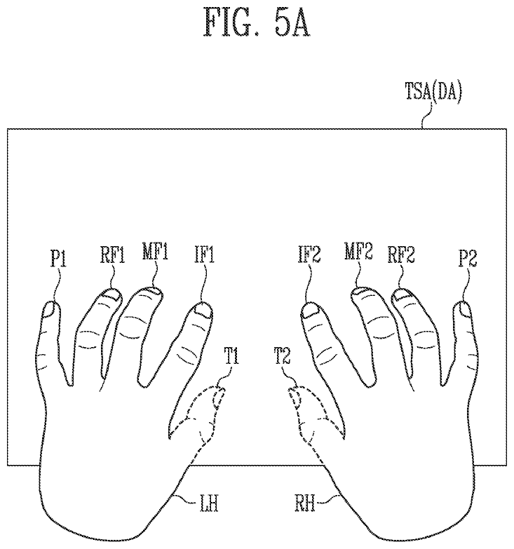

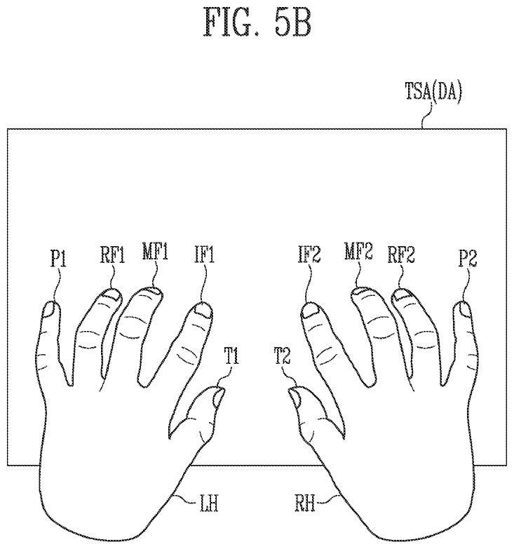

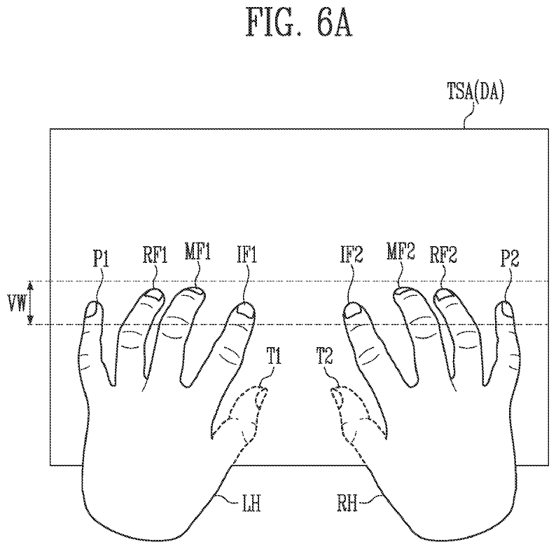

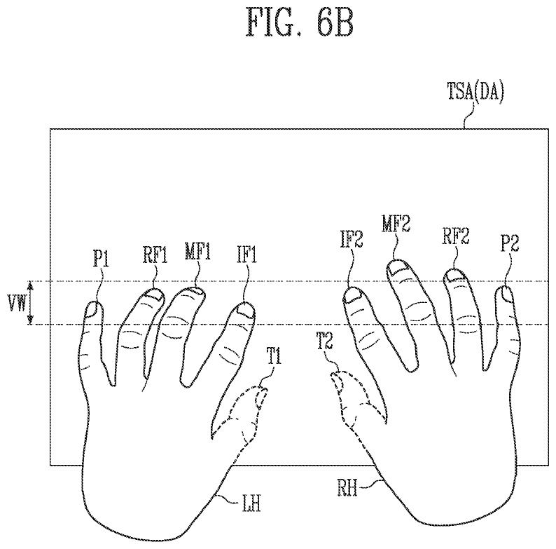

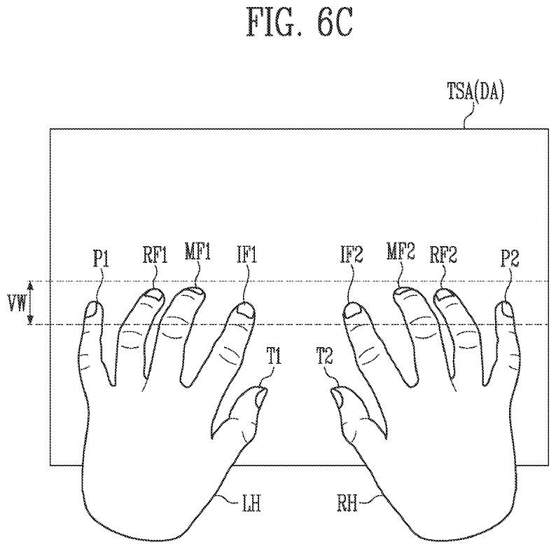

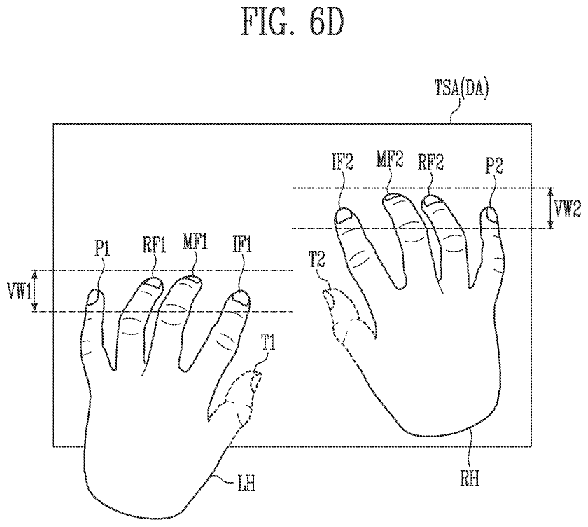

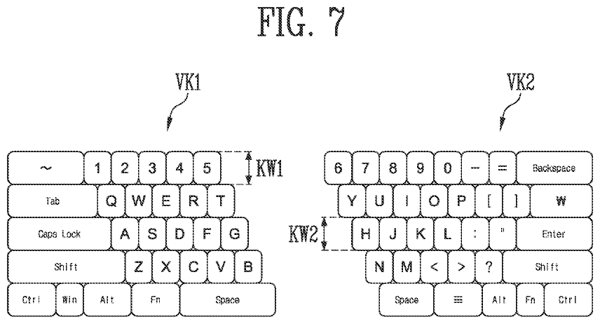

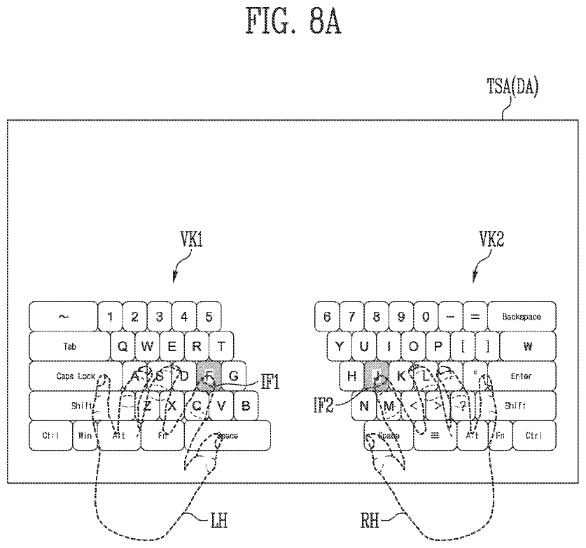

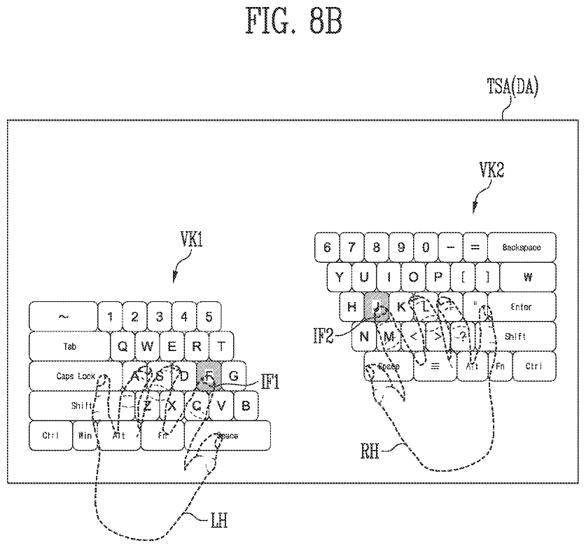

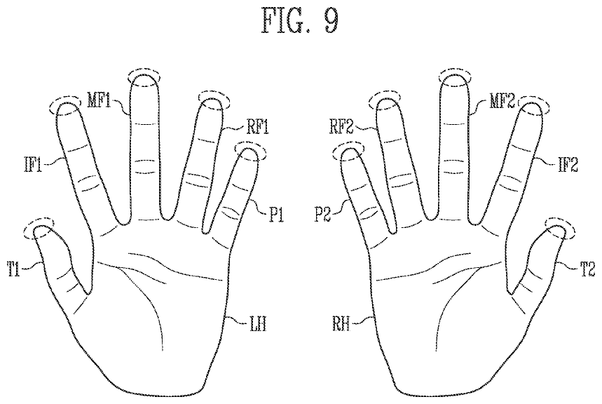

FIG. 1 is a block diagram of a display device in accordance with an embodiment of the present invention. FIG. 2 is a block diagram of a display device in accordance with an embodiment of the present invention. FIG. 3 is a perspective view of the display device shown in FIG. 1. FIG. 4 is a perspective view of the display device shown in FIG. 2. FIGS. 5A and 5B are diagrams for explaining a calculation operation of a touch sensor. FIGS. 6A, 6B, 6C and 6D are diagrams for explaining a detection operation of the touch sensor. FIG. 7 is a diagram for explaining a virtual keyboard according to an embodiment. FIGS. 8A and 8B are diagrams illustrating examples of implementing the virtual keyboard. FIG. 9 is a diagram for explaining pre-registered fingerprints according to an embodiment.

Referring to FIGS. 1, 2 and 3, a display device 100 may include a touch sensor 110, a controller 120, and a display 130. The display device 100 may be implemented in various shapes. For example, the display device 100 may be provided in the form of a rectangular plate having two pairs of sides parallel to each other. When the display device 100 is provided in the form of a rectangular plate, one pair of sides among two pairs of sides may be provided longer than the other pair of sides.

The display device 100 may display an image through a display surface. The display surface may be parallel to a plane defined by a first direction axis corresponding to a first direction DR1 and a second direction axis corresponding to a second direction DR2. A normal direction of the display surface (e.g., a thickness direction of the display device DD) may extend in a third direction DR3.

The display device 100 may be implemented as a flexible display device. For example, the display device 100 may be implemented as a foldable display device, a bendable display device, a rollable display device, and the like. However, the present invention is not limited thereto, and the display device 100 may be implemented as a rigid display device in other embodiments.

The display device 100 may be implemented as a large-sized electronic device (e.g., a television, monitor, electronic display board, or the like) or a small or medium-sized electronic device, e.g., a mobile phone, tablet, navigation device, game machine, smart watch, or the like. Also, the display device 100 may be implemented as a wearable electronic device such as, but not limited to, a head-mounted display.

The touch sensor 110 may be disposed above the display device 100. The touch sensor 110 may include a touch sensing area TSA and a touch non-sensing area NTSA located on at least one side of the touch sensing area TSA. For example, the touch non-sensing area NTSA may be provided to partially or entirely surround the touch sensing area TSA.

The touch sensing area TSA may be an area where an external input (for example, a user touch input) is sensed. An input sensing circuit (or input sensing electrodes) for sensing the external input may be provided in the touch sensing area TSA. Wirings and/or pads connected to the input sensing circuit (or input sensing electrodes) may be provided in the touch non-sensing area NTSA.

The touch sensor 110 may be implemented as a touch panel, a touch screen, or the like, to receive an external input. The touch sensor 110 may detect the external input to acquire information on an area where a touch event has occurred. In an embodiment, the touch sensor 110 may calculate the number of fingers of a user's left hand LH (e.g., first fingers) and the number of fingers of the user's right hand RH (e.g., second fingers) input to the touch sensing area TSA overlapping the display area DA. As discussed in greater detail below, the numbers of first and second fingers input to the touch sensing area may be all or some of the fingers of a user. In one embodiment, the number of first fingers and may be the same or different from the number of second fingers.

Referring to FIGS. 1, 3, and 5A, when first fingers IF1, MF1, RF1, and P1 (except for a thumb T1) of the user's left hand LH and second fingers IF2, MF2, RF2, and P2 (except for a thumb T2) of the user's right hand RH are input to the touch sensing area TSA overlapping the display area DA, the touch sensor may calculate the number of first fingers as four and may calculate the number of second fingers as four. FIG. 5A shows a case (using dotted lines) in which thumbs T1 and T2 are excluded from the user's touch input, but the present invention is not limited thereto. In other embodiments, the touch sensor may include the user's thumbs as explained in embodiments discussed below.

Referring to FIGS. 1, 3, and 5B, when first fingers T1, IF1, MF1, RF1, and P1 of the user's left hand LH and second fingers T2, IF2, MF2, RF2, and P2 of the user's right hand RH are input to the touch sensing area TSA overlapping the display area DA, the touch sensor 110 may calculate the number of first fingers as five and may calculate the number of second fingers as five.

In an embodiment, the touch sensor 110 may detect an arrangement (or pattern) of the first fingers of the user's left hand LH and the second fingers of the user's right hand RH, among the user's fingers input to the touch sensing area TSA.

Referring to FIGS. 1, 3, and 6A, when the first fingers IF1, MF1, RF1, and P1 (except for the thumb T1) of the user's left hand LH and the second fingers IF2, MF2, RF2, and P2 (except for the thumb T2) of the user's right hand RH input to (e.g., contacting) the touch sensing area TSA, overlapping the display area DA are disposed within a predetermined virtual width VW, the touch sensor 110 may detect that the first fingers and the second fingers are arranged in a line, e.g., a horizontal line. In one embodiment, the virtual width VW may be a distance between virtual lines centered on an index finger IF1 of the user's left hand LH or an index finger IF2 of the user's right hand RH. In one embodiment, the virtual width VW may be equal to a width of at least one key included in the virtual keyboard. In FIG. 6A and FIG. 6B to be described later, virtual lines (e.g., see horizontal broken lines) centered on the index finger IF1 of the user's left hand LH are shown as an example.

Referring to FIGS. 1, 3, and 6B, when at least one of the first fingers IF1, MF1, RF1, and P1 (except for the thumb T1) of the user's left hand LH and/or at least one of the second fingers IF2, MF2, RF2, and P2 (except for the thumb T2) of the user's right hand RH input to the touch sensing area TSA, overlapping the display area DA are disposed outside the virtual width VW, the touch sensor 110 may detect that the first fingers and the second fingers are not arranged in a predetermined arrangement (or pattern), e.g., in a horizontal line. FIG. 6B shows, as an example, a case in which a middle finger MF2 and a ring finger RF2 (among the second fingers IF2, MF2, RF2, and P2 except for the thumb T2) of the user's right hand RH input to the touch sensing area TSA are disposed outside the virtual width VW.

Referring to FIGS. 1, 3, and 6C, when the first fingers T1, IF1, MF1, RF1, and P1 of the user's left hand LH and the second fingers T2, IF2, MF2, RF2, and P2 of the user's right hand RH are input to the touch sensing area TSA overlapping the display area DA, the touch sensor 110 may detect an arrangement of the rest of the first fingers IF1, MF1, RF1, and P1 and the rest of the second fingers IF2, MF2, RF2, and P2 except for the thumbs T1 and T2. For example, when detecting the arrangement of 10 fingers including the thumbs T1 and T2, the touch sensor 110 may detect only the arrangement of 8 fingers except for the thumbs T1 and T2.

In an embodiment, the touch sensor 110 may individually detect the arrangement of the first fingers of the user's left hand LH and/or the second fingers of the user's right hand RH, among the user's fingers input to the touch sensing area TSA.

Referring to FIGS. 1, 3, 6D, and 7, when the first fingers IF1, MF1, RF1, and P1 (except for the thumb T1) of the user's left hand LH are disposed within a first virtual width VW1, the touch sensor 110 may detect that the first fingers are arranged in a line, e.g., a horizontal line. Here, the first virtual width VW1 may be a distance between virtual lines (broken lines) centered on a predetermined finger (e.g., index finger IF1) of the user's left hand LH, and in one or more embodiments may be equal to a width KW1 of at least one key included in a first virtual keyboard VK1 controlled by the user's left hand LH.

When the second fingers IF2, MF2, RF2, and P2 (except for the thumb T2) of the user's right hand RH are disposed within a second virtual width VW2, the touch sensor 110 may detect that the second fingers are arranged in a line, e.g., a horizontal line. The second virtual width VW2 may be, for example, a distance between virtual lines (broken lines) centered on a predetermined finger (e.g., index finger IF2) of the user's right hand RH, and may be equal to a width KW2 of at least one key included in a second virtual keyboard VK2 controlled by the user's right hand RH. In one embodiment, the horizontal arrangement of the fingers on the user's left hand and the horizontal arrangement of fingers on the user's right hand may correspond to different horizontal lines. For example, the fingers on the user's left hand may touch an area of the touch sensor 110 that is not in horizontal alignment with the fingers on the user's right hand, as illustrated, for example, in FIG. 6D. The first virtual width VW1 and the second virtual width VW2 may be the same width or different widths.

The touch sensor 110 may provide information acquired from an area where a touch event occurs (e.g., the calculated number of fingers and/or the arrangement of the detected fingers) to the controller 120.

Referring to FIGS. 1 and 3, the display 130 may be disposed below the touch sensor 110. The display 130 may include a display area and a non-display area located on at least one side of the display area. For example, the non-display area may be provided to entirely or partially surround the display area. At least a portion of the display area may overlap the touch sensing area TSA. At least a portion of the non-display area may overlap the touch non-sensing area NTSA.

The display area may be an area where an image is displayed. At least one pixel may be provided in the display area, and an image may be displayed on the display 130 by light emitted from the at least one pixel. The non-display area may be an area in which an image is not displayed. Wirings and/or pads connected to at least one pixel may be provided in the non-display area.

In accordance with one or more embodiments, the display 130 may display at least one virtual keyboard on the display area. For example, the display 130 may display a first virtual keyboard to be controlled by the user's left hand and a second virtual keyboard to be controlled by the user's right hand on the display area (e.g., refer to FIGS. 8A and 8B). In this case, the first and second virtual keyboards may be spaced from, or discontinuous relative to, one another (e.g., see FIG. 7). In one embodiment, an area where the first virtual keyboard is displayed and an area where the second virtual keyboard is displayed may not overlap each other. In another embodiment, the first and second virtual keyboards may be continuously displayed relative to one another, e.g., may correspond to the entire keyboard without spacings or discontinuities. The virtual keyboard(s) displayed on the display area of the display 130 may provide a keyboard function that is separate from a hardware keyboard. For illustrative purposes, the first and second virtual keyboards may collectively be referred to as a virtual keyboard in some portions of the discussion which follow.

In one embodiment, the display 130 may be implemented as a display panel including a self-light emitting element. For example, the display 130 may be implemented as a display panel including an organic light emitting diode (OLED). In this case, a light emitting layer may be formed of an organic light emitting layer, a quantum dot light emitting element (in which a light emitting layer is formed of a quantum dot light emitting layer), or the like. However, the present invention is not limited thereto, and the display 130 may be implemented as a liquid crystal (LC) display panel or another type of display in other embodiments.

Referring to FIG. 1, the controller 120 may display the virtual keyboard (e.g., either a single complete keyboard, or the first and second virtual keyboards previously discussed) on the display area of the display 130 based on information provided by the touch sensor 110. In an embodiment, the controller 120 may control whether to display the virtual keyboard by determining whether the sum of the number of user's fingers calculated by the touch sensor 110 is greater than or equal to a predetermined reference value. Here, the predetermined reference value may be a minimum value for the display device 100 to output the virtual keyboard. The minimum value may be a predetermined number, for example, 8 to indicate that the fingers on both hands of the user are touching the touch sensor of the display. In other embodiments, the minimum value may be different from eight (e.g., three or four or more), either on one hand or on both hands.

For example, when the sum of the number of first fingers of the user's left hand and the number of second fingers of the user's right hand (among the user's fingers detected by the touch sensor 110) is less than the predetermined reference value, the controller 120 may not display the virtual keyboard on the display 130. For example, when the sum of the number of user's fingers calculated by the touch sensor 110 is less than the reference value, the controller 120 may determine that the user's touch input is not for the purpose of typing on a keyboard and thus may limit output (or display) of the virtual keyboard. Therefore, an unintentional output (or display) of the virtual keyboard can be prevented.

In an embodiment, when the sum of the number of first fingers of the user's left hand and the number of second fingers of the user's right hand (among the user's fingers detected by the touch sensor 110) is greater than or equal to the predetermined reference value, the controller 120 may display the virtual keyboard (e.g., either an entire keyboard, or the first virtual keyboard VK1 and the second virtual keyboard VK2 previously discussed) on the display area of the display 130 according to an arrangement of the first fingers and the second fingers.

Referring to FIGS. 1, 5A, 6A, and 8A, when the sum of the number of first fingers IF1, MF1, RF1, and P1 (e.g., four) and the number of second fingers IF2, MF2, RF2 and P2 (e.g., four) detected by the touch sensor 110 is 8 (e.g., greater than or equal to the reference value of 8), and the detected first and second fingers are arranged in a horizontal line, the controller 120 may display the first virtual keyboard VK1 to be controlled by the user's left hand and the second virtual keyboard VK2 to be controlled by the user's right hand on the display area DA of the display 130.

Referring to FIGS. 1, 5B, 6C, and 8A, when the sum of the number of first fingers T1, IF1, MF1, RF1, and P1 (e.g., five) and the number of second fingers T2, IF2, MF2, RF2, and P2 (e.g., five) detected by the touch sensor 110 is 10 (e.g., greater than the reference value of 8), and the rest of the first fingers except for a thumb of the user's left hand and the rest of the second fingers except for a thumb of the user's right hand are arranged in a horizontal line, the controller 120 may display the first virtual keyboard VK1 to be controlled by the user's left hand and the second virtual keyboard VK2 to be controlled by the user's right hand on the display area DA of the display 130. Of course, in other embodiments the sum of the number of first fingers and the sum of the number of second fingers may be different from 8 or 10, e.g., less than 8. Also, the sum of the number of first fingers may be different from the sum of the number of second fingers, provided the aggregate thereof satisfies the predetermined reference value.

Referring to FIGS. 1, 6D, and 8B, when the sum of the number of first fingers IF1, MF1, RF1, and P1 (e.g., four) and the number of second fingers IF2, MF2, RF2, and P2 (e.g., four) detected by the touch sensor 110 satisfies a predetermined reference value (e.g., greater than or equal to the reference value of 8), and the detected first and second fingers are arranged in a horizontal line, the controller 120 may display the first virtual keyboard VK1 to be controlled by the user's left hand and the second virtual keyboard VK2 to be controlled by the user's right hand on the display area DA of the display 130.

As shown in FIGS. 8A and 8B, the controller 120 may display the first virtual keyboard VK1 in an area corresponding to the user's left hand detected by the touch sensor 110 and display the second virtual keyboard VK2 in an area corresponding to the user's right hand detected by the touch sensor 110. For example, the controller 120 may adjust positions at which the first virtual keyboard VK1 and the second virtual keyboard VK2 are output based on information provided by the touch sensor 110.

On the other hand, referring to FIGS. 1 and 6B, the controller 120 may not display the virtual keyboard on the display area DA of the display 130 when the first fingers and the second fingers are not arranged in a horizontal line. For example, when the arrangement of the user's fingers detected by the touch sensor 110 is not arranged in a horizontal line, the controller 120 may determine that the user's touch input is not for typing on a keyboard. Thus, the controller 120 may not output (or display) of the virtual keyboard. Therefore, unintentional output (or display) of the virtual keyboard can be prevented.

In an embodiment, the controller 120 may display the first virtual keyboard on the display area of the display 130 based on a predetermined finger (e.g., the index finger) of the user's left hand, and may display the second virtual keyboard on the display area of the display 130 based on a predetermined finger (e.g., the index finger) of the user's right hand. In other embodiments, the predetermined finger may be different from an index finger.

Referring to FIGS. 1, 8A, and 8B, the controller 120 may display the first virtual keyboard VK1 (in which a plurality of keys are arranged on the display area DA of the display 130) based on a predetermined key (e.g., F key or another key) corresponding to the index IF1 of the user's left hand LH input to the touch sensing area TSA. In addition, the controller 120 may display the second virtual keyboard VK2 (in which a plurality of keys are arranged on the display area DA of the display 130) based on a predetermined key (e.g., J key or another key) corresponding to the index finger IF2 of the user's right hand RH input in the touch sensing area TSA.

Referring to FIGS. 2 and 4, a display device 100′ may include the touch sensor 110, the controller 120, the display 130, and a fingerprint sensor 140. For example, unlike the display device 100 shown in FIGS. 1 and 3, the display device 100′ may further include the fingerprint sensor 140. Hereinafter, contents overlapping with those described above will be omitted or briefly described.

In one embodiment, the fingerprint sensor 140 may be disposed below the display 130. The fingerprint sensor 140 may include a fingerprint sensing area and a fingerprint non-sensing area located on at least one side of the fingerprint sensing area. For example, the fingerprint non-sensing area may be provided in a form partially or completely surrounding the fingerprint sensing area. At least a portion of the fingerprint sensing area may overlap the touch sensing area TSA. Also, at least a portion of the fingerprint sensing area may overlap the display area. At least a portion of the fingerprint non-sensing area may overlap the touch non-sensing area NTSA. Also, at least a portion of the fingerprint non-sensing area may overlap the non-display area.

The fingerprint sensing area may be an area where a user's fingerprint is sensed. The fingerprint sensor 140 may include a plurality of individual sensors. At least one of the individual fingerprint sensors used to detect the user's fingerprint may be provided in the fingerprint sensing area. The at least one of the individual fingerprint sensors may be implemented, for example, using an optical method, an ultrasonic method, a capacitive method, or the like. Wirings and/or pads connected to at the individual fingerprint sensors may be provided in the fingerprint non-sensing area. In one embodiment, the fingerprint sensor 140 may be implemented as a fingerprint sensing panel or the like.

The fingerprint sensor 140 may acquire fingerprint information (or a fingerprint image) by detecting the user's fingerprint input into the fingerprint sensing area. In an embodiment, the fingerprint sensor 140 may detect fingerprints of first fingers of the user's left hand and fingerprints of second fingers of the user's right hand, among the user's fingers input to the fingerprint sensing area overlapping the touch sensing area TSA. The fingerprint sensor 140 may provide the acquired fingerprint information (or fingerprint image) to the controller 120.

The controller 120 may display a virtual keyboard on the display area of the display 130 based on the fingerprint information (or fingerprint image) provided by the fingerprint sensor 140. In this case, it is assumed that the number of fingers included in the user's touch input is greater than or equal to the predetermined reference value and that the fingers are arranged in a predetermined pattern, e.g., a horizontal line. For example, when the information (e.g., the number and arrangement of fingers included in the user's touch input) provided by the touch sensor 110 satisfies the above conditions, the controller 120 may further determine the fingerprint information (or fingerprint image) provided by the fingerprint sensor 140 and display the virtual keyboard on the display area of the display 130.

In an embodiment, the controller 120 may control whether to display the virtual keyboard by: comparing the fingerprints of the first fingers of the user's left hand input to the fingerprint sensing area overlapping the touch sensing area TSA with pre-registered first fingerprints, and comparing the fingerprints of the second fingers of the user's right hand input to the fingerprint sensing area overlapping the touch sensing area TSA with pre-registered second fingerprints.

Referring to FIGS. 7 and 9, the pre-registered first and second fingerprints may be fingerprints (or fingerprint images) of the user's fingers stored in advance, in order to allow the controller 120 to determine whether the user's touch input is for typing on a keyboard.

In one embodiment, the pre-registered first fingerprints may be fingerprints (or fingerprint images) corresponding to uppermost ends of last nodes of the first fingers corresponding to the user's left hand LH. For example, the pre-registered first fingerprints may include fingerprints (or fingerprint images) corresponding to uppermost ends of last nodes of the thumb T1, index finger IF1, middle finger MF1, ring finger RF1, and small finger P1 of the user's left hand LH. The pre-registered second fingerprints may be fingerprints (or fingerprint images) corresponding to uppermost ends of last nodes of the second fingers corresponding to the user's right hand RH. For example, the pre-registered second fingerprints may include fingerprints (or fingerprint images) corresponding to uppermost ends of last nodes of the thumb T2, index finger IF2, middle finger MF2, ring finger RF2, and small finger P2 of the user's right hand RH.

When the fingerprints of the first fingers input to the fingerprint sensing area (overlapping the touch sensing area TSA) match the pre-registered first fingerprints, and when the fingerprints of the second fingers input to the fingerprint sensing area (overlapping the touch sensing area TSA) match the pre-registered second fingerprints, the controller 120 may display the virtual keyboard on the display area of the display 130. Thus, in one embodiment, authenticated fingerprint identification may serve as a pre-condition to displaying the virtual keyboard on the display area.

In addition, in an embodiment where the virtual keyboard includes first and second virtual keyboards VK1 and VK2, when the fingerprints of the first fingers input to the fingerprint sensing area (overlapping the touch sensing area TSA) match the pre-registered first fingerprints, the controller 120 may display the first virtual keyboard VK1 controlled by the user's left hand on the display area of the display 130. Similarly, when the fingerprints of the second fingers input to the fingerprint sensing area (overlapping the touch sensing area TSA) match the pre-registered second fingerprints, the controller 120 may display the second virtual keyboard VK2 controlled by the user's right hand on the display area of the display 130.

On the other hand, when at least one of the fingerprints of the first fingers input to the fingerprint sensing area overlapping the touch sensing area TSA does not match the pre-registered first fingerprints, and at least one of the fingerprints of the second fingers input to the fingerprint sensing area overlapping the touch sensing area TSA does not match the pre-registered second fingerprints, the controller 120 may not display the virtual keyboard on the display area of the display 130. For example, when at least one of the fingerprints of the user's fingers detected by the fingerprint sensor 140 does not match the pre-registered fingerprints (e.g., the first fingerprints and the second fingerprints), the controller 120 may determine that the user's touch input is not for the purpose of typing on a keyboard and, accordingly, may not output (or display) the virtual keyboard. Therefore, unintentional output (or display) of the virtual keyboard can be prevented.

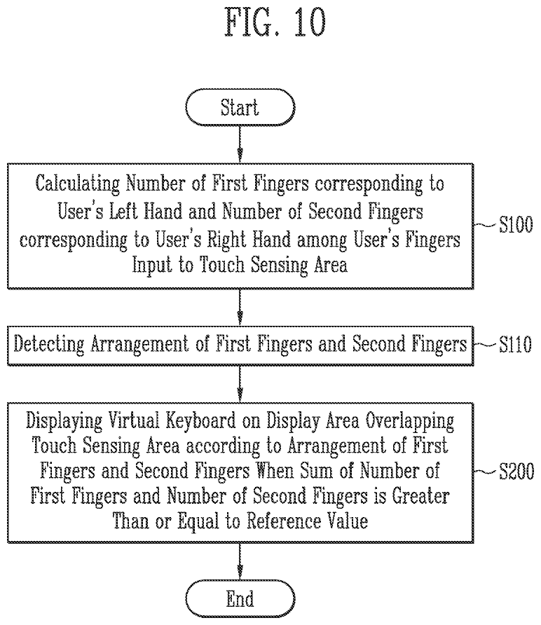

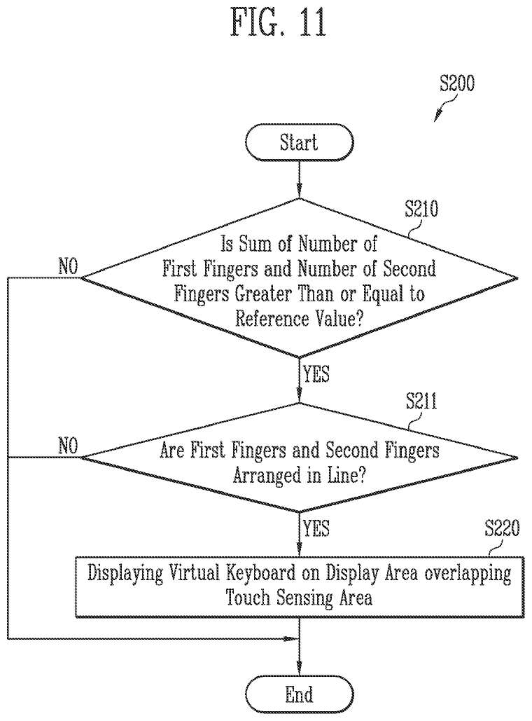

FIGS. 10 and 11 are block diagrams for explaining a method for driving a display device in accordance with an embodiment of the present invention.

Referring to FIG. 10, the driving method may include calculating the number of first fingers of a user's left hand and the number of second fingers of a user's right hand among user's fingers input to a touch sensing area (S100), detecting an arrangement of the first fingers and the second fingers (S110), and displaying a virtual keyboard on a display area overlapping the touch sensing area according to the arrangement of the first fingers and the second fingers when the sum of the number of the first fingers and the number of the second fingers is greater than or equal to a reference value (S200).

In the operation S100, the number of first fingers of the user's left hand and the number of second fingers of the user's right hand, among the user's fingers input to the touch sensing area, may be calculated. For example, referring to FIG. 5A, the number of first fingers IF1, MF1, RF1, and P1 input to the touch sensing area TSA may be calculated as four, and the number of second fingers IF2, MF2, RF2, and P2 input to the touch sensing area TSA may be calculated as four. Referring to FIG. 5B, the number of first fingers T1, IF1, MF1, RF1, and P1 input to the touch sensing area TSA may be calculated as five, and the number of second fingers T2, IF2, MF2, RF2, and P2 input to the touch sensing area TSA may be calculated as five.

In operation S110, the arrangement of the first fingers and the second fingers input to the touch sensing area may be detected. Referring to FIG. 6A, when the first fingers IF1, MF1, RF1, and P1 (except for the thumb T1) of the user's left hand LH and the second fingers IF2, MF2, RF2, and P2 (except for the thumb T2) of the user's right hand RH are input to the touch sensing area, and the input first fingers IF1, MF1, RF1, and P1 and the input second fingers IF2, MF2, RF2, and P2 are arranged within the virtual width VW, it may be detected that the first fingers and the second fingers are arranged according to a predetermined arrangement or pattern, e.g., in a horizontal line.

Referring to FIG. 6C, when the first fingers T1, IF1, MF1, RF1, and P1 including the thumb T1 of the user's left hand LH and the second fingers T2, IF2, MF2, RF2, and P2 including the thumb T2 of the user's right hand RH are input to the touch sensing area, and the first fingers IF1, MF1, RF1, and P1 (except for the thumb T1) of the user's left hand LH and the second fingers IF2, MF2, RF2, and P2 (except for the thumb T2) of the user's right hand RH are arranged within the virtual width VW, it may be detected that the first fingers and the second fingers are arranged in a predetermined arrangement or pattern, e.g., a horizontal line.

Referring to FIG. 6D, when the first fingers IF1, MF1, RF1, P1 (except for the thumb T1) of the user's left hand LH and the second fingers IF2, MF2, RF2, P2 (except for the thumb T2) of the user's right hand RH are input to the touch sensing area, it may be detected that the first fingers are arranged in a horizontal line when the input first fingers IF1, MF1, RF1, and P1 are arranged within the first virtual width VW1, and it may be detected that the second fingers are arranged in a horizontal line when the input second fingers IF2, MF2, RF2, and P2 are arranged within the second virtual width VW2.

Referring to FIG. 6B, when the first fingers IF1, MF1, RF1, and P1 (except for the thumb T1) of the user's left hand LH and the second fingers IF2, MF2, RF2, and P2 (except for the thumb T2) of the user's right hand RH are input to the touch sensing area, it may be detected that the first fingers and the second fingers are not aligned in a predetermined pattern (e.g., horizontal line) when at least one of the input first fingers IF1, MF1, RF1, and P1 and/or at least one of the input second fingers IF2, MF2, RF2, and P2 is arranged to extend beyond the virtual width VW.

Referring to FIGS. 10 and 11, operation S200 may include determining whether the sum of the number of first fingers and the number of second fingers is greater than or equal to a predetermined reference value (S210), determining whether the first fingers and the second fingers are arranged in a predetermined pattern (e.g., horizontal line) (S211), and displaying the virtual keyboard on the display area overlapping the touch sensing area (S220).

Based on the result obtained in operation S210, operation S211 may be performed when the sum of the number of first fingers and the number of second fingers input to the touch sensing area is greater than or equal to the predetermined reference value. When the sum of the number of the first fingers and the number of second fingers input to the touch sensing area is less than the predetermined reference value, it may be determined that the user's touch input is not for the purpose of typing on a keyboard. In this case, the virtual keyboard may not be output (or displayed). Here, the reference value may be a predetermined minimum value for outputting the virtual keyboard, e.g., 8 or another number.

Based, for example, on the result obtained by operation S211, operation S220 may be performed when the first fingers and the second fingers input to the touch sensing area are arranged in a predetermined arrangement or pattern, e.g., a horizontal line. When the first fingers and the second fingers input to the touch sensing area are not arranged in the predetermined pattern (e.g., horizontal line), it may be determined that the user's touch input is not for the purpose of typing on a keyboard, and the virtual keyboard may not be output (or displayed).

In operation S220, when the sum of the number of first fingers and the number of second fingers input to the touch sensing area is greater than or equal to the predetermined reference value and the first fingers and the second fingers are arranged in a predetermined pattern (e.g., horizontal line), the virtual keyboard may be displayed on the display area overlapping the touch sensing area. The predetermined pattern may be different from a horizontal line in other embodiments.

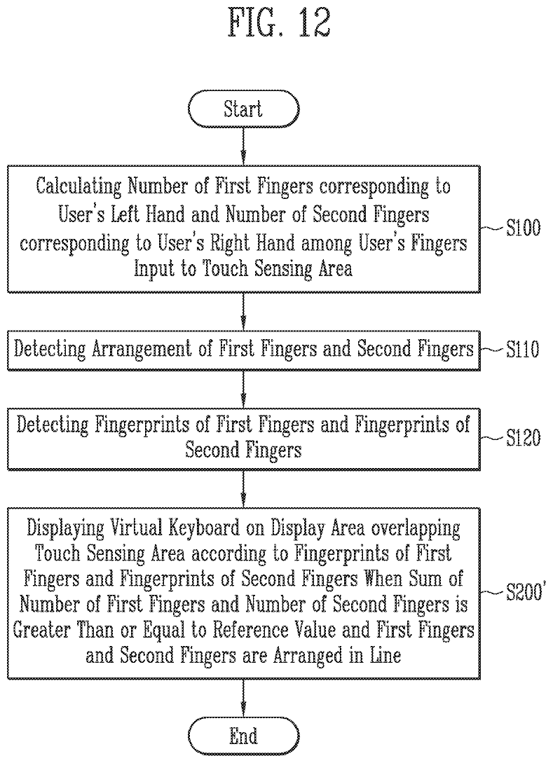

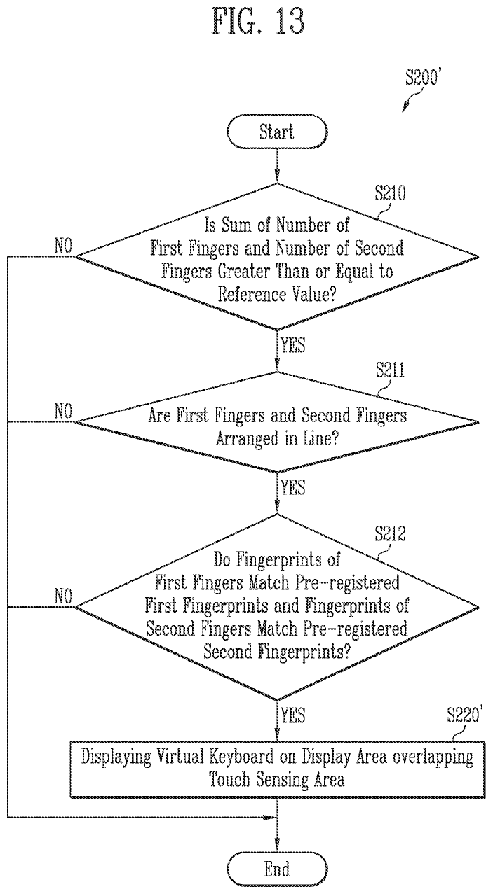

FIGS. 12 and 13 are block diagrams for explaining a method for driving a display device in accordance with an embodiment of the present invention. Hereinafter, contents overlapping with those described above will be omitted or briefly described.

Referring to FIG. 12, the driving method may include calculating the number of first fingers of a user's left hand and the number of second fingers of the user's right hand among user's fingers input to a touch sensing area (S100), detecting an arrangement of the first fingers and the second fingers (S110), detecting fingerprints of the first fingers and fingerprints of the second fingers input to a fingerprint sensing area overlapping the touch sensing area (S120), and displaying a virtual keyboard on a display area overlapping the touch sensing area according to the fingerprints of the first fingers and the fingerprints of the second fingers, when the sum of the number of first fingers and the number of second fingers is greater than or equal to a predetermined reference value and the first fingers and the second fingers are arranged in a predetermined arrangement or pattern, e.g., a horizontal line (S200′).

In operation S120, the fingerprints of the first fingers and the fingerprints of the second fingers input to the fingerprint sensing area overlapping the touch sensing area may be detected. For example, operation S120 may be performed when the display device includes a fingerprint sensor (or at least one individual fingerprint sensor) capable of detecting a user's fingerprint.

Referring to FIGS. 12 and 13, operation S200′ may include determining whether the sum of the number of first fingers and the number of second fingers is greater than or equal to the predetermined reference value (S210), determining whether the first fingers and the second fingers are arranged in a predetermined arrangement or pattern, e.g., a horizontal line (S211), determining whether the fingerprints of the first fingers match pre-registered first fingerprints and whether the fingerprints of the second fingers match pre-registered second fingerprints (S212), and displaying the virtual keyboard on the display area overlapping the touch sensing area (S220′) when a match exists.

Based on a matching result of operation S212, operation S220′ may be performed when the fingerprints of the first fingers input to the fingerprint sensing area overlapping the touch sensing area match the pre-registered first fingerprints and the fingerprints of the second fingers input to the fingerprint sensing area overlapping the touch sensing area match the pre-registered second fingerprints.

When there is no match in operation S212 (e.g., when at least one of the fingerprints of the first fingers input to the fingerprint sensing area overlapping the touch sensing area does not match the pre-registered first fingerprints and/or at least one of the fingerprints of the second fingers input to the fingerprint sensing area overlapping the touch sensing area does not match the pre-registered second fingerprints), it may be determined that the user's touch input is not for the purpose of typing on a keyboard, and the virtual keyboard may not be output (or displayed).

In operation S220′, when the sum of the number of first fingers and the number of second fingers input to the touch sensing area is greater than or equal to the predetermined reference value, the first fingers and the second fingers are determined to be arranged in a predetermined arrangement or pattern, e.g., a horizontal line. When it is also the case that the fingerprints of the first fingers input to the fingerprint sensing area overlapping the touch sensing area match the pre-registered first fingerprints, and the fingerprints of the second fingers input to the fingerprint sensing area overlapping the touch sensing area match the pre-registered second fingerprints, the virtual keyboard may be displayed on the display area overlapping the touch sensing area.

In accordance to one or more of the aforementioned embodiments of the present invention, unintentional output (or display) of a virtual keyboard can be prevented by selectively outputting the virtual keyboard according to the user's touch state. However, effects of the present invention are not limited to the above-described effects, and may be variously extended without departing from the spirit and scope of the present invention.

Although the present invention has been specifically described according to the above-described embodiments, it should be noted that the above-described embodiments are intended to illustrate the present invention and not to limit the scope of the present invention. Those of ordinary skill in the art to which the present invention pertains will understand that various modifications are possible within the scope of the technical spirit of the present invention.

Therefore, the technical protection scope of the present invention is not limited to the detailed description described in the specification, but should be determined by the appended claims. In addition, all changes or modifications derived from the meaning and scope of the claims and their equivalents should be construed as being included in the scope of the present invention. The embodiments may be combined to form additional embodiments.

What is claimed is:

1. A display device comprising:
a display which includes a display area;
a touch sensor configured to detect first fingers and second fingers input to a touch sensing area overlapping the display area, the first fingers located on a user's left hand and the second fingers located on the user's right hand; and
a controller configured to display a virtual keyboard on the display area when:
an arrangement of the first fingers and the second fingers corresponds to a predetermined arrangement, and
a sum of a number of the first fingers and a number of the second fingers detected by the touch sensor is greater than or equal to a predetermined reference value.

2. The display device of claim 1, wherein:
the predetermined arrangement is a horizontal line, and
the controller is configured to display the virtual keyboard on the display area when the first fingers and the second fingers are arranged in the horizontal line.

3. The display device of claim 2, wherein:
the first fingers and the second fingers are arranged in a horizontal line when the first fingers and the second fingers lie within a virtual width, the virtual width corresponding to a width of at least one key included in the virtual keyboard.

4. The display device of claim 1, wherein the predetermined reference value is 8.

5. The display device of claim 1, wherein:
when the first fingers include a thumb of the user's left hand and the second fingers include a thumb of the user's right hand, the controller is configured to display the virtual keyboard on the display area when remaining ones of the first fingers except for the thumb of the user's left hand and remaining ones of the second fingers except for the thumb of the user's right hand are arranged in the predetermined arrangement.

6. The display device of claim 1, wherein the virtual keyboard includes a first virtual keyboard controlled by the user's left hand and a second virtual keyboard controlled by the user's right hand.

7. The display device of claim 6, wherein the controller is configured to display the first virtual keyboard on the display area based on a position of an index finger of the user's left hand and to display the second virtual keyboard on the display area based on a position of an index finger of the user's right hand.

8. The display device of claim 6, wherein an area where the first virtual keyboard is displayed and an area where the second virtual keyboard is displayed are spaced from each other.

9. The display device of claim 1, further comprising:
a fingerprint sensor configured to detect fingerprints of the first fingers and fingerprints of the second fingers input to a fingerprint sensing area overlapping the touch sensing area,
wherein the controller is configured to compare the fingerprints of the first fingers detected by the fingerprint sensor with pre-registered first fingerprints and to compare the fingerprints of the second fingers detected by the fingerprint sensor with pre-registered second fingerprints as a pre-condition to display of the virtual keyboard on the display area.

10. The display device of claim 9, wherein the controller is configured to display the virtual keyboard on the display area when the fingerprints of the first fingers match the pre-registered first fingerprints and the fingerprints of the second fingers match the pre-registered second fingerprints.

11. The display device of claim 9, wherein:
the pre-registered first fingerprints are fingerprints corresponding to uppermost ends of last nodes of the first fingers, and
the pre-registered second fingerprints are fingerprints corresponding to uppermost ends of last nodes of the second fingers.

12. A method of driving a display device, the method comprising:
calculating a number of first fingers corresponding to a user's left hand and a number of second fingers corresponding to a user's right hand input to a touch sensing area;
detecting an arrangement of the first fingers and the second fingers; and
displaying a virtual keyboard on a display area overlapping the touch sensing area when:
the arrangement of the first fingers and the second fingers correspond to a predetermined arrangement, and
a sum of the number of the first fingers and the number of the second fingers is greater than or equal to a predetermined reference value.

13. The method of claim 12, wherein:
displaying the virtual keyboard includes displaying the virtual keyboard on the display area when the first fingers and the second fingers are arranged in the predetermined arrangement, and
the predetermined arrangement is a horizontal line.

14. The method of claim 13, wherein:
the first fingers and the second fingers are arranged within a virtual width, and
the virtual width corresponds to a width of at least one key included in the virtual keyboard.

15. The method of claim 12, wherein the predetermined reference value is 8.

16. The method of claim 12, wherein:
when the first fingers include a thumb of the user's left hand and the second fingers include a thumb of the user's right hand, displaying the virtual keyboard includes displaying the virtual keyboard on the display area when remaining ones of the first fingers except for the thumb of the user's left hand and remaining ones of the second fingers except for the thumb of the user's right hand are arranged in the predetermined arrangement, and
the predetermined arrangement is a horizontal line.

17. The method of claim 12, wherein displaying the virtual keyboard includes displaying on the display area:
a first virtual keyboard controlled by the user's left hand, and
a second virtual keyboard controlled by the user's right hand.

18. The method of claim 17, wherein displaying the virtual keyboard includes:
displaying the first virtual keyboard on the display area based on a position of an index finger of the user's left hand, and
displaying the second virtual keyboard on the display area based on a position of an index finger of the user's right hand.

19. The method of claim 12, further comprising:
detecting fingerprints of the first fingers and fingerprints of the second fingers input to a fingerprint sensing area overlapping the touch sensing area, wherein displaying the virtual keyboard includes:
displaying the virtual keyboard on the display area when the fingerprints of the first fingers match pre-registered first fingerprints and the fingerprints of the second fingers match pre-registered second fingerprints.

20. The method of claim 19, wherein:
the pre-registered first fingerprints correspond to uppermost ends of last nodes of the first fingers, and
the pre-registered second fingerprints correspond to uppermost ends of last nodes of the second fingers.

21. A display device, comprising:
a touch sensor; and
a controller configured to display a virtual keyboard,
wherein the touch sensor detects a number of fingers on a touch sensing area overlapping a display area, and
wherein the controller is configured to automatically display the virtual keyboard when at least one condition is satisfied, the at least one condition including a first condition that the number of fingers detected by the touch sensor is greater than or equal to a predetermined reference value.

22. The display device of claim 21, wherein the fingers detected on the touch sensing area are on different hands of a user.

23. The display device of claim 22, wherein the fingers detected on the touch sensing area are on a same hand of a user.

24. The display device of claim 21, wherein:
the at least one condition includes a second condition, and
the second condition is that the number of detected fingers are arranged in a predetermined pattern.

25. The display device of claim 24, wherein the predetermined pattern includes the number of fingers arranged on a horizontal line.

26. The display device of claim 21, wherein:
the virtual keyboard includes a first virtual keyboard and a second virtual keyboard, and
the first virtual keyboard has different keys from the second virtual keyboard.

27. The display device of claim 26, wherein the controller is configured to display the first virtual keyboard based on a position of a predetermined finger on a user's left hand and is configured to display the second virtual keyboard based on a position of a predetermined finger on the user's right hand.

28. The display device of claim 21, further comprising:
a fingerprint sensor configured to detect fingerprints of the number of fingers on the touch sensing area, and
wherein the at least one condition includes a second condition, the second condition corresponding to a match between the detected fingerprints and pre-registered fingerprints of the user.
